(19) United States
(12) Patent Application Publication
(10) Pub. No.: US 2022/0369679 A1
(43) Pub. Date: Nov. 24, 2022

(54) KIMCHI POWDER AND METHOD OF PREPARING THE SAME

(71) Applicant: LUCID KITCHEN CO., LTD., Seongju-gun (KR)

(72) Inventor: Jee Young Kang, Seoul (KR)

(21) Appl. No.: 17/467,543

(22) Filed: Sep. 7, 2021

(30) Foreign Application Priority Data
May 21, 2021 (KR) 10-2021-0065636

(51) Int. Cl. A23L 19/00; A23L 3/44; A23L 19/20; A23L 27/10; A23L 5/20

(52) U.S. Cl. CPC A23L 19/01; A23L 3/44; A23L 19/20; A23L 27/105; A23L 5/276

(57) ABSTRACT

Provided is a method of preparing kimchi powder. The method includes preparing kimchi, aging and storing the kimchi at low temperature, freeze-drying the kimchi, and grinding the kimchi into powder, wherein, in the aging and storing of the kimchi at low temperature, the kimchi is aged and stored at −2° C. for three months, and the freeze-drying of the kimchi is performed after the aging and storing of the kimchi at low temperature is performed.

### CROSS-REFERENCE TO RELATED APPLICATION

This application claims priority to and the benefit of Korean Patent Application No. 10-2021-0065636, filed on May 21, 2021, the disclosure of which is incorporated herein by reference in its entirety.

### BACKGROUND

### 1. Field of the Invention

The present invention relates to kimchi powder and a method of preparing the same.

### 2. Discussion of Related Art

Kimchi is a fermented food made from vegetables such as napa cabbages, radishes, young radishes, cucumbers, large green onions, and garlic chives as main raw materials and represents Korean indigenous traditional food. As unique nutritional properties of kimchi are scientifically revealed one after another, kimchi is widely known internationally, and thus the number of people who eat kimchi is increasing.

Recently, according to the trend of commercialization of kimchi products, various applied products such as unfermented kimchi, ripe kimchi, aged kimchi, finished products of kimchi stew, and the like have been released. However, there are not many kimchi powder releases yet. Particularly, there is a lack of development of kimchi powder that makes good use of an intrinsic taste of kimchi.

Accordingly, the inventor of the present invention has completed the present invention after long research and trial and error for kimchi powder and a method of preparing the same.

### SUMMARY OF THE INVENTION

The present invention is directed to providing kimchi powder that makes good use of an intrinsic taste of kimchi, and a method of preparing the same.

Meanwhile, other objects not specified in the present invention will be additionally considered within the range that can be easily inferred from the following detailed description and effects thereof.

According to an aspect of the present invention, there is provided a method of preparing kimchi powder, which includes preparing kimchi, aging and storing the kimchi at low temperature, freeze-drying the kimchi, and grinding the kimchi into powder, wherein, in the aging and storing of the kimchi at low temperature, the kimchi is aged and stored at −2° C. for three months, and the freeze-drying of the kimchi is performed after the aging and storing of the kimchi at low temperature is performed.

The preparing of the kimchi may include preparing brine, pickling napa cabbage using the brine, washing the pickled napa cabbage, dehydrating the washed napa cabbage, preparing seasoning including red pepper powder, salted seafood, garlic, ginger, onion, radish, large green onion, and garlic chive, and combining the dehydrated napa cabbage and the seasoning. In the pickling of the napa cabbage, the brine may have a salinity of 9 to 13% and common salt corresponding to 3.5 to 6.0% of an amount of napa cabbage may be additionally introduced. The pickling of the napa cabbage may be performed for four to seven hours. In the washing of the pickled napa cabbage, the amount of the introduced napa cabbage may be 50 kg/min or less, an amount of washing water may be 50 L/min or more, a washing time may be one to two minutes, and the washing water may be replaced every three hours.

The preparing of the kimchi may include, before the pickling of the napa cabbage using the brine is performed, cutting the napa cabbage, disinfecting the cut napa cabbage, and washing the disinfected napa cabbage. A chlorine concentration of chlorine disinfectant used in the disinfecting of the cut napa cabbage may range from 50 to 100 ppm.

The preparing of the seasoning may include disinfecting the garlic and the ginger, washing agricultural products including the garlic, the ginger, the onion, the radish, the large green onion, and the garlic chive, cutting and grinding the agricultural products, and mixing the red pepper powder, the salted seafood, and the agricultural products.

A chlorine concentration of chlorine disinfectant used in the disinfecting of the garlic and the ginger may be 200 ppm. In the washing of the agricultural products including the garlic, the ginger, the onion, the radish, the large green onion, and the garlic chive, an input amount of the agricultural products, that is, an input amount of garlic, ginger, onion, and radish may be 20 kg/min or less and an input amount of large green onion and garlic chive may be 3 kg/min or less, an amount of washing water may be 15 L/min or more, a washing time may be 1 minute or more, and the washing water may be replaced every time an ingredient of the agricultural products is changed.

The preparing of the kimchi may further include, after the combining of the dehydrated napa cabbage and the seasoning is performed, detecting a metal in the kimchi.

According to an aspect of the present invention, there is provided kimchi powder prepared according to a method of preparing kimchi powder which includes preparing kimchi, aging and storing the kimchi at low temperature, freeze-drying the kimchi, and grinding the kimchi into powder, wherein, in the aging and storing of the kimchi at low temperature, the kimchi is aged and stored at −2° C. for three months, and the freeze-drying of the kimchi is performed after the aging and storing of the kimchi at low temperature is performed.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a method of preparing kimchi powder according to an embodiment of the present invention;

FIG. 2 is a diagram illustrating operations of preparing kimchi in the method of preparing the kimchi powder according to the embodiment of the present invention; and

FIG. 3 shows an actual appearance of kimchi powder prepared according to the embodiment of the present invention.

It is revealed that the accompanying drawings are exemplified as a reference for understanding the technical idea of the present invention, and the scope of the present invention is not limited thereby.

### DETAILED DESCRIPTION OF EXEMPLARY EMBODIMENTS

When embodiments of the present invention are described, when it is determined that the detailed descriptions of known technology related to the present invention unnecessarily obscure the subject matter of the invention, the detailed descriptions will be omitted.

The terminology used herein is for the purpose of describing particular embodiments only and is not intended to be limiting to the present invention. As used herein, the singular forms “a” and “an” are intended to also include the plural forms, unless the context clearly indicates otherwise. It should be further understood that the terms “comprise,” “comprising,” “include,” and/or “including,” when used herein, specify the presence of stated features, integers, steps, operations, elements, parts, or combinations thereof but do not preclude the presence or addition of one or more other features, integers, steps, operations, elements, parts, or combinations thereof.

Hereinafter, embodiments of kimchi powder and a method of preparing the same according to the present invention will be described in detail with reference to the accompanying drawings. In the description with reference to the accompanying drawings, the same or corresponding components are given the same reference numerals and descriptions thereof will not be repeated.

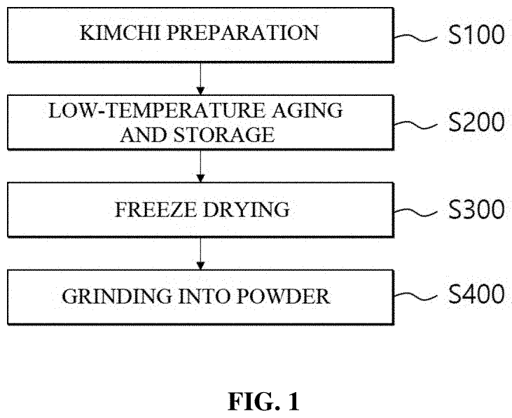

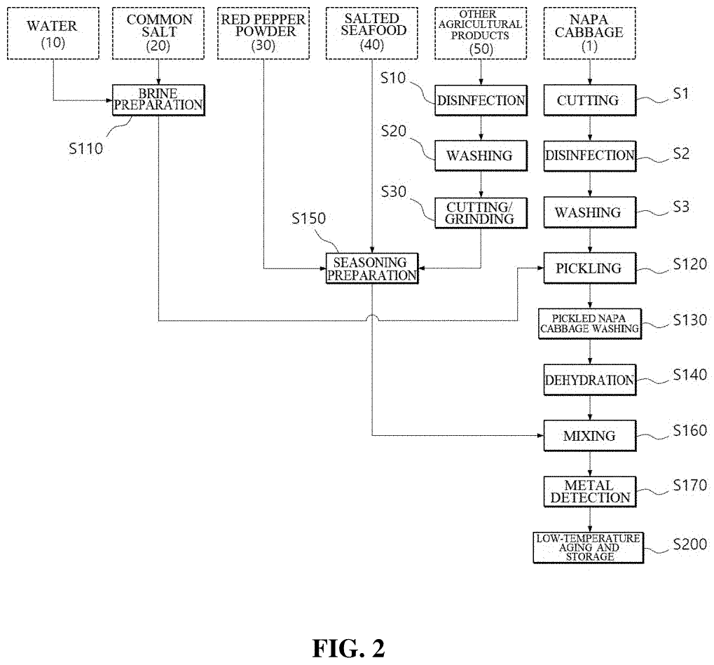

FIG. 1 is a diagram illustrating a method of preparing kimchi powder according to an embodiment of the present invention. FIG. 2 is a diagram illustrating operations of preparing kimchi in the method of preparing the kimchi powder according to the embodiment of the present invention.

Referring to FIG. 1, the method of preparing the kimchi powder according to the embodiment of the present invention may include an operation S100 of preparing kimchi (S100), an operation S200 of aging and storing the kimchi at low temperature (S200), an operation S300 of freeze-drying the kimchi (S300), and an operation S400 of grinding the freeze-dried kimchi into powder (S400).

Referring to FIG. 2, the operation S100 of preparing the kimchi may include an operation S110 of preparing brine, an operation S120 of pickling napa cabbage, an operation S130 of washing the pickled napa cabbage, an operation S140 of dehydrating the washed napa cabbage, an operation S150 of preparing seasoning, and an operation S160 of combining the napa cabbage and the seasoning and may further include an operation S170 of detecting a metal.

The operation S110 of preparing the brine is an operation of preparing brine by mixing water 10 and common salt 20. The water 10 is limited to potable water according to the water quality inspection report of the waterworks office. The common salt 20 may include at least one of refined salt (Korean traditional salt), sawmill salt (flower salt), and sea salt. The brine may be prepared in a brine tank. The water 10 and the common salt 20 may be introduced into the brine tank. The brine may have a salinity of 9 to 13%. For example, water of 2,560 L and refined salt (Korean traditional salt) of 320 kg may be mixed so that a salinity of brine may be 12%. For example, water of 1,920 L and refined salt (Korean traditional salt) of 240 kg may be mixed so that a salinity of brine may be 12%. The brine tank may be provided with a salinity meter.

Napa cabbage 1 for pickling may be provided after a separate preparation process is performed. An operation of providing napa cabbage may include a cutting operation S 1, a disinfecting operation S2, and a washing operation S3.

The cutting operation S1 is an operation of taking napa cabbage, which is stored in an environment of 5° C. or less, out and cutting the napa cabbage. The napa cabbage may be cut into halves or quarters. When the napa cabbage is cut, decaying parts, degraded parts, and inedible parts of the napa cabbage may be removed. A knife used for removing the decaying parts, the degraded parts, and the inedible parts may be sterilized with an ultraviolet sterilizer.

The disinfecting operation S2 is an operation of disinfecting the cut napa cabbage. The disinfecting operation S2 may be accomplished by an air washer and a chlorine (sodium hypochlorite) injector. When disinfecting with chlorine, a chlorine concentration may range from 50 to 100 ppm. A water temperature may be maintained at 10° C. or lower. Between the cutting operation S1 and the disinfecting operation S2, foreign substances may be removed from the napa cabbage by vibration. In addition, the napa cabbage may be selected according to preset criteria. For example, when there is a non-standard part, only the non-standard part may be removed or napa cabbage having a non-standard part may be excluded from the preparing of the kimchi.

The washing operation S3 may be performed by an air washer. The water temperature of washing water may be maintained at 10° C. or lower.

After the washing operation S3 is performed, a first selection process may be performed to remove the foreign substances, the non-standard parts, and the inedible parts.

The washed (or washed and then selected) napa cabbage may be provided to the operation S120 of pickling the napa cabbage.

The operation S120 of pickling the napa cabbage is an operation of pickling the provided napa cabbage using the brine. The pickling of the napa cabbage is done in a pickling container, and the napa cabbage and the brine are introduced into the pickling container. In the operation S120 of pickling the napa cabbage, additional common salt may be introduced. The additional common salt may be the same as the common salt described above. The additional common salt may be sprinkled directly on the napa cabbage. An added amount of additional common salt may range from 3.5 to 6.0% of an amount of napa cabbage. The added amount of additional common salt may range from 8 to 11 kg. The napa cabbage may be loaded into the pickling container and each napa cabbage may be salted. When the napa cabbage is loaded up to the top of the pickling container, a press plate and a press container may be placed on the napa cabbage. The operation S120 of pickling the napa cabbage may be performed for four to seven hours. The operation S120 may take four to seven hours after the press plate and the press container are placed.

The operation S130 of washing the pickled napa cabbage is an operation of washing the napa cabbage to remove some salt from the pickled napa cabbage. A washing time may range from one to two minutes. An amount of washing water may be 50 L/min or more. 25 L of washing water may be used for each bunch of napa cabbage. An input amount of napa cabbage may be 50 kg/min or less. The washing water may be replaced every three hours. The water temperature may be maintained at 10° C. or lower. After the washing is performed, the napa cabbage may have a salinity of 2.8±0.2%.

After the operation S130 of washing the pickled napa cabbage is performed, a second selection process may be performed to remove foreign substances, non-standard parts, and inedible parts.

The operation S140 of dehydrating the washed napa cabbage is an operation of removing water from the napa cabbage. The dehydrating of the napa cabbage may be performed by a dehydration container. The napa cabbage containing moisture may be accommodated in the dehydration container and dehydrated naturally. For example, the napa cabbage may be loaded into the dehydration container, and the water may be drained from the napa cabbage over time. A dehydration time may range from two to twelve hours.

The operation S150 of preparing the seasoning is an operation of preparing the seasoning used for kimchi and, as the seasoning, red pepper powder 30, salted seafood 40, and other agricultural products 50 may be used. In the operation S150 of preparing the seasoning, processed foods such as fructose and sugar and additives such as lactic acid and a D-sorbitol solution may be further used. In addition, fruits such as apples, pears, and the like may be further used.

The red pepper powder 30 may include coarse red pepper powder and/or fine red pepper powder. The red pepper powder may be used after foreign substances and inedible parts are removed according to preset criteria.

The salted seafood 40 may include at least one of saury fish sauce and anchovy fish sauce. The salted seafood 40 may be stored in an environment of 5° C. or less. The salted seafood 40 may be salted seafood aged for three years.

The other agricultural products 50 may include garlic, ginger, onion, radish, large green onion, and garlic chive. The other agricultural products 50 may be stored in an environment of 5° C. or less. The other agricultural products 50 may go through a selection process in which decaying parts, degraded parts, and inedible parts are removed. A knife used in the selection process may be sterilized with an ultraviolet sterilizer.

The other agricultural products 50 may be provided to the operation S150 of preparing the seasoning after a disinfection operation S10, a washing operation S20, and a cutting/grinding operation S30 are performed.

The disinfection operation S10 may be performed on the garlic and the ginger among the other agricultural products. The disinfection operation S10 may be performed by an air washer and a chlorine (sodium hypochlorite) injector. When disinfecting with chlorine, a chlorine concentration may be 200 ppm. The water temperature may be maintained at 11° C. or lower. A disinfection time may be five minutes. The disinfected garlic and the ginger may be washed twice or more under running water so that residual chlorine may be removed.

The washing operation S20 is an operation of washing the onion, the radish, the large green onion, and the garlic chive, including the disinfected garlic and the ginger, with water. An input amount of the agricultural products, that is, an input amount of garlic, ginger, onion, and radish may be 20 kg/min or less and an input amount of large green onion and garlic chive may be 3 kg/min or less. An amount of washing water may be 15 L/min or more, a washing time may be 1 minute or more, and the washing water may be replaced every time an ingredient of the agricultural products is changed.

The cutting/grinding operation S30 is an operation of cutting and grinding the washed agricultural products to a predetermined size. In this operation, a cutter and a grinder may be used.

The operation S150 of preparing the seasoning is an operation of mixing the prepared red pepper powder, salted seafood, and cut/ground agricultural products according to the amount of a mixing ratio. As described above, the processed foods such as fructose and sugar and the additives such as lactic acid and a D-sorbitol solution may be further mixed. In addition, the fruits such as apples, pears, and the like may be further mixed.

The seasoning in which the ingredients are mixed may be aged. An aging and storage temperature may range from 0 to 10° C. and an aging time may be 24 hours or more.

The operation S160 of combining the napa cabbage and the seasoning is an operation of mixing and tossing the dehydrated napa cabbage and the seasoned seasoning. A mixing (tossing) time may range from 70 to 100 seconds. After the mixing is performed, the kimchi may have a salinity of 2.3±0.2%, sugar content of 12±1%, and pH of 5.0±0.2.

The operation S170 of detecting the metal is an operation of detecting the metal in the mixed and prepared kimchi. For example, a metal such as Fe, stainless use steel (SUS), or the like may be detected. Fe of 3 mm or more should not be detected and SUS of 4 mm or more should not be detected, but criteria thereof are not limited thereto.

The operation S170 of detecting the metal may be performed by a method of passing the kimchi through a metal detector while moving the kimchi on a conveyor. When a detection signal is generated, the corresponding kimchi may re-pass therethrough, and when the metal is detected even in the case in which the kimchi re-passes therethrough, the corresponding kimchi may be excluded or managed separately.

The operation S200 of aging and storing the kimchi at low temperature is an operation of aging and storing the kimchi at low temperature in a packed or unpacked state. The kimchi in the packed state may be packed with a packing material such as a polyethylene terephthalate (PET) container or a bottle. The kimchi in the unpacked state may be accommodated in a storage container. The storage container may be sealed or open. The kimchi may be aged and stored in a low-temperature warehouse and may be aged and stored at −2° C. for three months.

The mixing ratio of the kimchi may be as follows. (unit: weight %, error range: ±0.5)

napa cabbage (napa cabbage of 98.3%, common salt of 1.7%): 74.38%,

anchovy stock (anchovy stock sauce of 2.2%, purified water of 97.8%): 9.17%,

red pepper powder: 2.39%,

garlic chive: 2.35%,

anchovy fish sauce: 1.97%,

D-sorbitol solution: 1.97%,

onion: 1.84%,

garlic: 1.83%,

paste of glutinous rice (glutinous rice of 10%, purified water of 90%): 1.09%,

large green onion: 1.04%,

common salt: 0.64%,

white sugar: 0.61%,

ginger: 0.39%,

fructose: 0.12%,

saury fish sauce: 0.12%, and

lactic acid: 0.09%.

[Table 1] below shows results of a sensory test that is performed on the kimchi prepared with the above mixing ratio in a case in which a low-temperature aging storage temperature and a storage period are set differently.

Conditions of the sensory test are as follows.
Number of test subjects: 30
A case of eating only kimchi or a case of eating kimchi with white rice
Scores: 1 to 5 (1: very poor, 2: poor, 3: average, 4: good, 5: very good)

TABLE 1

| | | | Comparative | Comparative | Comparative | Comparative |
|---|---|---|---|---|---|---|
| Conditions | | Example | Example 1 | Example 2 | Example 3 | Example 4 |
| Aging temperature | | −2° C. | 0° C. | 2° C. | −2° C. | −2° C. |
| Aging time | | 3 months | 3 months | 3 months | 1 month | 5 months |
| Sensory | Color | 4.9 | 4.6 | 4.3 | 4.3 | 4.4 |
| test | Taste | 4.8 | 4.5 | 4.5 | 4.5 | 4.6 |
| | Flavor | 4.7 | 4.4 | 4.6 | 4.6 | 4.6 |
| | Texture | 4.8 | 4.6 | 4.2 | 4.2 | 4.5 |
| | Preference | 4.8 | 4.6 | 4.5 | 4.4 | 4.5 |

The operation S300 of freeze-drying the kimchi is an operation of quick-freezing and drying the prepared and aged kimchi. The operation S300 of freeze-drying the kimchi may be performed after (directly after) the operation S200 of aging of the kimchi at low temperature is completed. When the aging of the kimchi at low temperature is completed, the kimchi may be freeze-dried while maintaining a state rich in lactic acid bacteria.

The quick-freezing of the kimchi may be performed at −50 to −30° C. for 10 to 15 hours. At a temperature higher than −30° C., the quick-freezing does not proceed and thus the taste and flavor of the kimchi may not be maintained. At a temperature lower than −50° C., the kimchi is supercooled, and thus the temperature is economically inefficient.

After the quick-freezing operation is completed, an operation of freeze-drying the kimchi by sublimating the frozen kimchi in a vacuum dryer may be performed. The freeze-drying operation may be performed under conditions of reduced pressure 0.01 to 4.58 mmHg at −15 to −40° C.

A vacuum freeze-drying operation may be performed several times. First to fifth drying operations may be performed, and the temperature may be gradually increased while the first to fifth drying operations are performed.

The operation S400 of grinding the freeze-dried kimchi into powder is an operation of grinding the freeze-dried kimchi into powder. The freeze-dried kimchi may be ground to form fine particles. The freeze-dried kimchi may pass through an oscillator or sieve equipped with a screen of 40 to 20 mesh size to make the particles even.

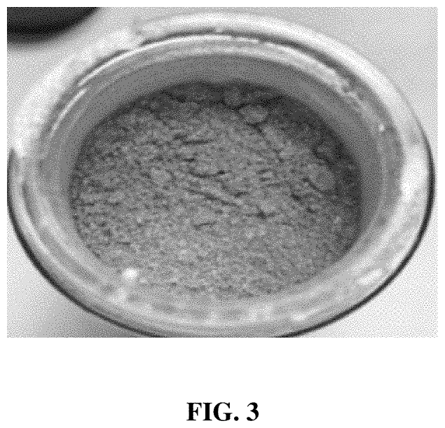

FIG. 3 shows an actual appearance of kimchi powder prepared according to the embodiment of the present invention.

[Table 2] below shows results of a sensory test for kimchi powder A prepared by grinding the kimchi, to which the embodiment of the present invention is applied, into powder, and results of a sensory test for kimchi powder B, C, and D prepared by grinding commercially available kimchi into powder. The freeze-drying and grinding conditions for all of the kimchi are the same.

Conditions of the sensory test are as follows.
Number of test subjects: 30
A case of eating only kimchi powder or a case of eating kimchi powder with other foods
Scores: 1 to 5 (1: very poor, 2: poor, 3: average, 4: good, 5: very good)

TABLE 2

| Items | Color | Taste | Flavor | Texture | Preference |
|---|---|---|---|---|---|
| A | 4.9 | 4.8 | 4.7 | 4.8 | 4.8 |
| B | 4.7 | 4.5 | 4.4 | 4.7 | 4.6 |
| C | 4.8 | 4.4 | 4.3 | 4.8 | 4.5 |
| D | 4.7 | 4.6 | 4.7 | 4.5 | 4.6 |

There is an effect in that the kimchi powder according to the present invention can be excellent in terms of color, flavor, taste, texture, and the like.

Meanwhile, even when it is an effect not explicitly described herein, it is added that the effects described in the following specification expected by the technical features of the present invention and their potential effects are treated as described in the specification of the present invention.

The protection scope of the present invention is not limited to the description and expression of the embodiments explicitly described above. In addition, it is added once again that the protection scope of the present invention cannot be limited due to obvious changes or substitutions in the art to which the present invention pertains.

What is claimed is:

1. A method of preparing kimchi powder, the method comprising:
preparing kimchi;
aging and storing the kimchi at low temperature;
freeze-drying the kimchi; and
grinding the kimchi into powder,
wherein, in the aging and storing of the kimchi at low temperature, the kimchi is aged and stored at −2° C. for three months, and
the freeze-drying of the kimchi is performed after the aging and storing of the kimchi at low temperature is performed.

2. The method of claim 1, wherein the preparing of the kimchi includes:
preparing brine;
pickling napa cabbage using the brine;
washing the pickled napa cabbage;
dehydrating the washed napa cabbage;
preparing seasoning including red pepper powder, salted seafood, garlic, ginger, onion, radish, large green onion, and garlic chive; and
combining the dehydrated napa cabbage and the seasoning,
wherein, in the pickling of the napa cabbage, the brine has a salinity of 9 to 13% and common salt corresponding to 3.5 to 6.0% of an amount of napa cabbage is additionally introduced,
the pickling of the napa cabbage is performed for four to seven hours, and
in the washing of the pickled napa cabbage, the amount of the introduced napa cabbage is 50 kg/min or less, an amount of washing water is 50 L/min or more, a washing time is one to two minutes, and the washing water is replaced every three hours.

3. The method of claim 2, wherein the preparing of the kimchi includes:
before the pickling of the napa cabbage using the brine is performed, cutting the napa cabbage;
disinfecting the cut napa cabbage; and
washing the disinfected napa cabbage,
wherein a chlorine concentration of chlorine disinfectant used in the disinfecting of the cut napa cabbage ranges from 50 to 100 ppm.

4. The method of claim 2, wherein the preparing of the seasoning includes:
disinfecting the garlic and the ginger;
washing agricultural products including the garlic, the ginger, the onion, the radish, the large green onion, and the garlic chive;
cutting and grinding the agricultural products; and
mixing the red pepper powder, the salted seafood, and the agricultural products.

5. The method of claim 4, wherein:
a chlorine concentration of chlorine disinfectant used in the disinfecting of the garlic and the ginger is 200 ppm; and
in the washing of the agricultural products including the garlic, the ginger, the onion, the radish, the large green onion, and the garlic chive, an input amount of the agricultural products, that is, an input amount of garlic, ginger, onion, and radish is 20 kg/min or less and an input amount of large green onion and garlic chive is 3 kg/min or less, an amount of washing water is 15 L/min or more, a washing time is 1 minute or more, and the washing water is replaced every time an item of the agricultural products is changed.

6. The method of claim 2, wherein the preparing of the kimchi further includes, after the combining of the dehydrated napa cabbage and the seasoning is performed, detecting a metal in the kimchi.

7. Kimchi powder prepared according to the method of claim 1.
